(19) United States
(12) Patent Application Publication
(10) Pub. No.: US 2015/0085474 A1
(43) Pub. Date: Mar. 26, 2015

(54) Beam support

(71) Applicant: Brett W. Sareyka, Glen Mills, PA (US)

(72) Inventor: Brett W. Sareyka, Glen Mills, PA (US)

(73) Assignee: Worthington Armstrong Venture

(21) Appl. No.: 13/987,982

(22) Filed: Sep. 20, 2013

(51) Int. Cl. F21S 8/04; F21K 99/00

(52) U.S. Cl. CPC F21S 8/046; F21K 9/30
USPC 362/147; 29/825

(57) ABSTRACT

Selected connections in a prior art suspended panel ceiling are modified to provide fixed cantilevered extensions that support aluminum beams (ABs) with light emitting diode (LED) lights. The ABs with LED lights can be installed in the suspended ceiling to the fixed cantilevered extensions after the prior art portion of the suspended ceiling is completed.

To create a fixed cantilevered extension, a second cross beam connector, preferably modified to provide an extended portion, is alone stabbed into a connection, without any attached second cross beam. Such fixed cantilevered extension is capable of subsequently having attached thereto, for support, a rolled aluminum beam (AB) with LED lights, after the prior art suspended ceiling is installed.

The installation of the ABs with LED lights, subsequent to the construction of the suspended ceiling with the supports of the invention, does not affect the ceiling resistance to earthquakes.

### BACKGROUND OF THE INVENTION

1. Field of the Invention

Suspended ceilings are used extensively in commercial and industrial buildings. In such ceilings, a metal grid framework, formed of interconnected T-beams, is hung from a structural ceiling by wires. The beams are roll-formed from continuous strips of sheet metal.

The grid supports panels in rectangular openings formed in the grid.

Such ceilings must resist earthquake tremors in accordance with applicable building codes:

This invention relates to a support, at selected locations in such grid, for an aluminum beam (AB) with light emitting diode (LED) lights. The support is installed at the time the suspended ceiling is constructed. The AB's with lights are installed later. By means of the invention, the suspended ceiling sustains its resistance to earthquakes with the AB's with LED lights installed, as in a prior-art ceiling without such AB's.

2. Prior Art

Suspended ceilings having folded sheet metal inverted T-beams interconnected at intersections into a grid that supports panels are well known. U.S. Pat. No. 7,926,238 ('238), for instance, incorporated herein by reference, shows such a ceiling.

The grid in such prior art ceilings has, at each grid intersection, a connection having a pair of opposing identical first and second cross beams connected respectively to first and second cross beam connectors, and to a main beam. To form such a prior art connection, the first and second cross beam connectors, fixed on the ends of opposing cross beams, are thrust, or stabbed-in, from opposing sides of the main beam, through a slot in the main beam, to connect with each other and with the main beam.

Numerous such stab-in connections at grid intersections are made to create a ceiling grid.

### BRIEF SUMMARY OF THE INVENTION

The present invention relates to the use of such prior art stab-in connections at grid intersections to form supports at selected locations for an aluminum grid (AB) with attached light emitting diode (LED) lights.

The prior art stab-in connection described above is modified to selectively create, as the ceiling grid is being installed, fixed cantilevered extensions at locations throughout a panel suspended ceiling, that is constructed in accordance with the applicable building codes, including those requirements relative to resistance to earthquakes. Aluminum beams (AB) with LED lights are later attached to the fixed cantilevered extensions, without disturbing the integrity of the suspended ceiling, including the resistance to such quakes.

The rolled sheet metal beams that are used in the grid of conventional prior art suspended ceilings, are not suitable to support LED lights.

In the present invention, the prior art stab-in connection referred to above, formed by a first cross beam connector on the end of a first cross beam that connects with an opposing identical second cross beam connector on the end of an opposing second cross beam, with both first and second cross beam connectors connecting with the main beam through the slot in the main beam, is modified.

The second cross beam connector, without any attached cross beam, is manually inserted into the slot, to connect with the opposing first cross beam connector on the end of the first cross beam, already in the slot, and the main beam. The second cross beam connector is desirably modified to provide an extended portion that enables the connector to be more easily manually inserted into the connector.

In either version described above, a fixed cantilevered extension is thus formed by the second cross beam connector, extending from the main beam and the first cross beam, that is capable of having attached thereto, and supporting, after such fixed cantilevered extension is created, the end of an AB with LED lights.

### BRIEF DESCRIPTION OF THE DRAWINGS

FIG. 1 is a right side elevational view of a prior art connection between identical first and second cross beam connectors attached to first and second cross beams. The first and second cross beam connectors extend through a slot in the main beam, to form a connector-to-connector, and a connectors to main beam, lock.

FIG. 1a is a top sectional view taken on the line 1a-1a in FIG. 1.

FIG. 2 is a right side elevational view similar to FIG. 1, of the fixed cantilevered extension of the invention, with no modification of the second cross beam connector.

FIG. 3 is an isometric view showing an aluminum beam (AB) about to be secured to the fixed cantilevered extension of the invention, with no modification of the second cross beam connector.

FIG. 4 is a view similar to FIG. 3 showing an aluminum beam (AB) fixed to the cantilevered extension of the invention for support.

FIG. 5 is a side elevational view of a preferred version of the invention, in which a modified second cross beam connector inserted in the connection that enables the second connector to be more easily inserted into the connection, and to more easily be attached to an AB beam.

FIG. 6 is a sectional view taken on the line 6-6 in FIG. 7.

FIG. 7 is a side elevational view similar to FIG. 5 showing an aluminum beam (AB) fixed to the modified second cross beam connector for support.

### DETAILED DESCRIPTION OF THE INVENTION

The '238 patent is representative of the prior art connection on which this invention is based. The connection itself, and the method of making such connection, is set forth in detail in the '238 patent.

Such connection conforms to building codes, including their requirements as to earthquake resistance.

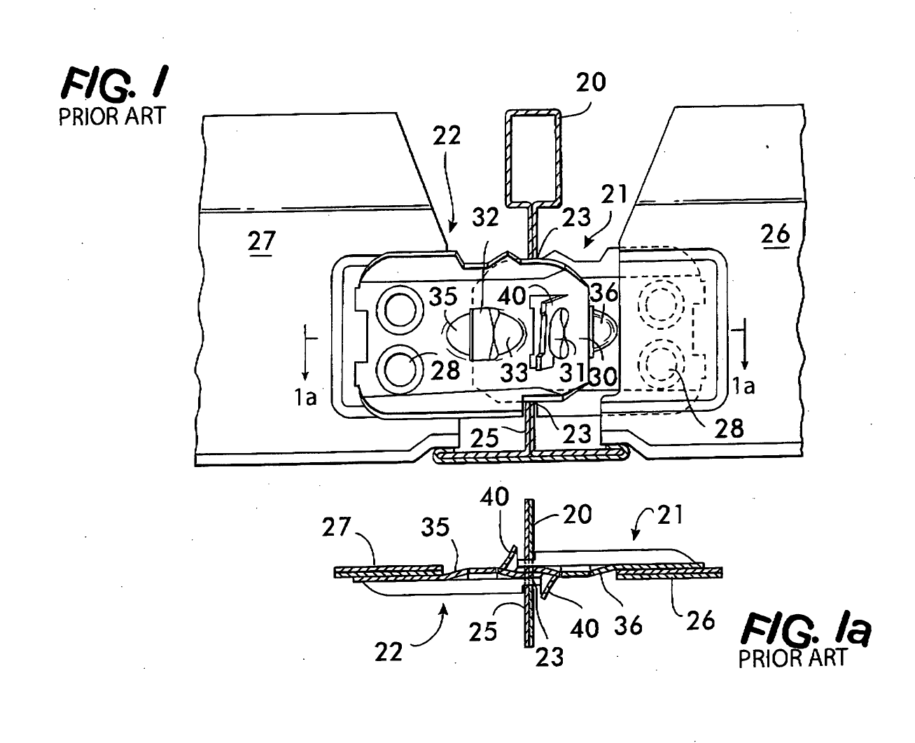

The prior art '238 connection on which the present invention is based, is shown in FIGS. 1 and 1a. Main beam 20, shown in cross section, extends longitudinally in a ceiling grid that supports panels. Identical first cross beam connector 21 and second cross beam connector 22, are attached to first cross beam 26 and second cross beam 27 respectively, by rivets 28. To make the prior art connection of FIG. 1, the first and second cross beam connectors 21 and 22, by means of attached first 26 and second 27 cross beams, are stabbed through a slot 23 in the web 25 of the main beam 20 and interconnect with each other and with the main beam 20.

In such prior art connection shown in FIGS. 1 and 1a, described above, the following occurs:
(1) End 30 of second cross beam connector 22 engages detent 31 to form a connector-to-connector connection, as does end 32 of first cross beam connector 21 engage detent 33;
(2) Locking latches 40 on first cross beam connector 21 and second cross beam connector 22 are in an unflexed position;
(3) Backstops 35 and 36 on connectors 21 and 22 secure the ends 30 and 32 in the connector-to-connector lock; and
(4) First and second connectors 21 and 22 are kept laterally and vertically constrained within slot 23 by the cross sectional configuration of the identical first connector 21 and second connector 22, as well known in the art.
(5) First cross beam 26 and second cross beam 27 extend outwardly, at right angles, from main beam 20.
   The general configuration so far described conforms to the prior art, and to building codes.

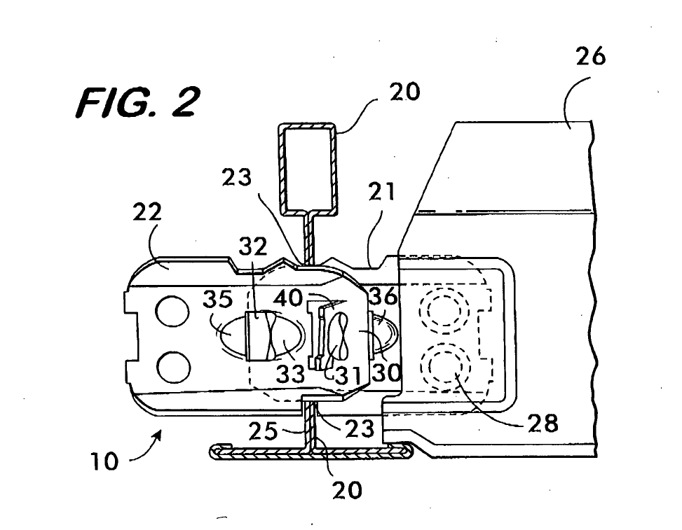

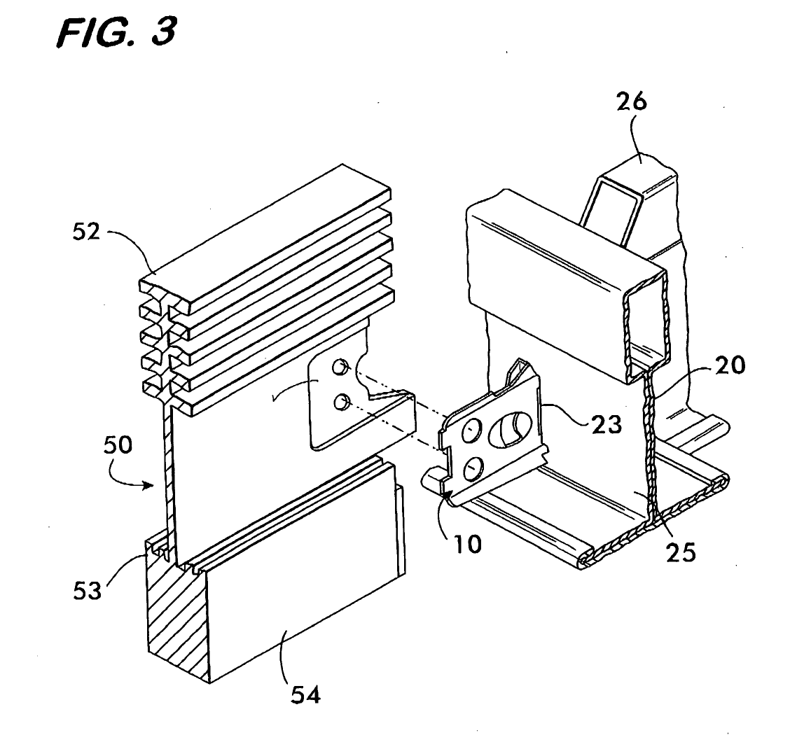

In a basic embodiment of the present invention, shown in FIG. 2, second cross beam connector 22 is manually stabbed, by itself, through slot 23 to form a connection by engaging the main beam 20 and opposing first cross beam connector 21 attached to first cross beam 26 as described above.

The result is a fixed cantilevered projection 10, as seen in FIG. 2, that is anchored to main beam 20, and first cross beam 26. The ceiling continues to conform to the building codes including the earthquake requirements, since the connection between the opposing first and second connectors, and the main beam remain the same.

Such fixed cantilevered projections 10 are constructed at opposing sides of suspended ceiling rectangular grid openings where aluminum beams (ABs) 50 with LED lights are to be placed. The ABs are generally rolled into an inverted-T cross section, with lower flanges 53 and 54, and upper fins 52.

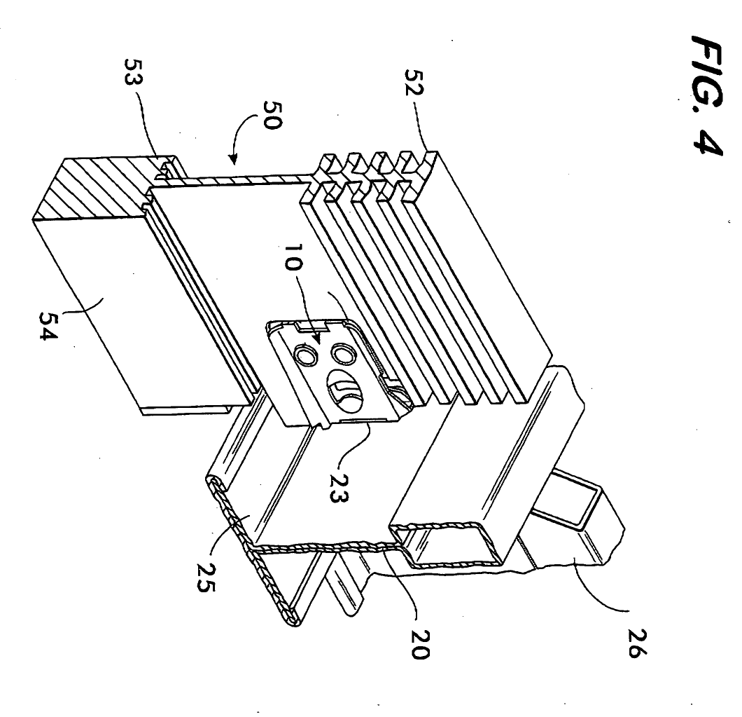

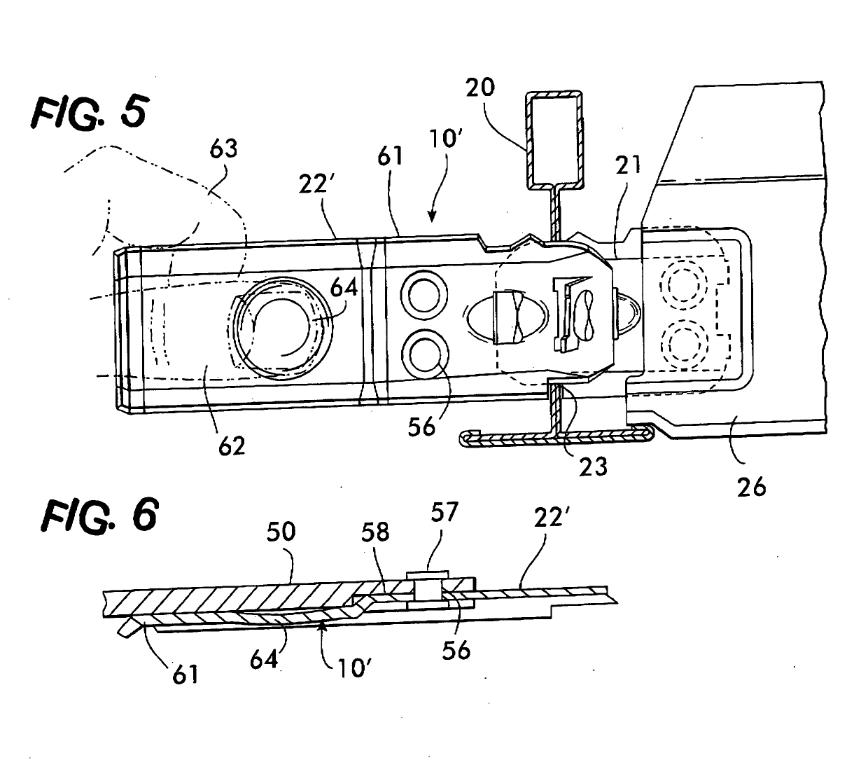

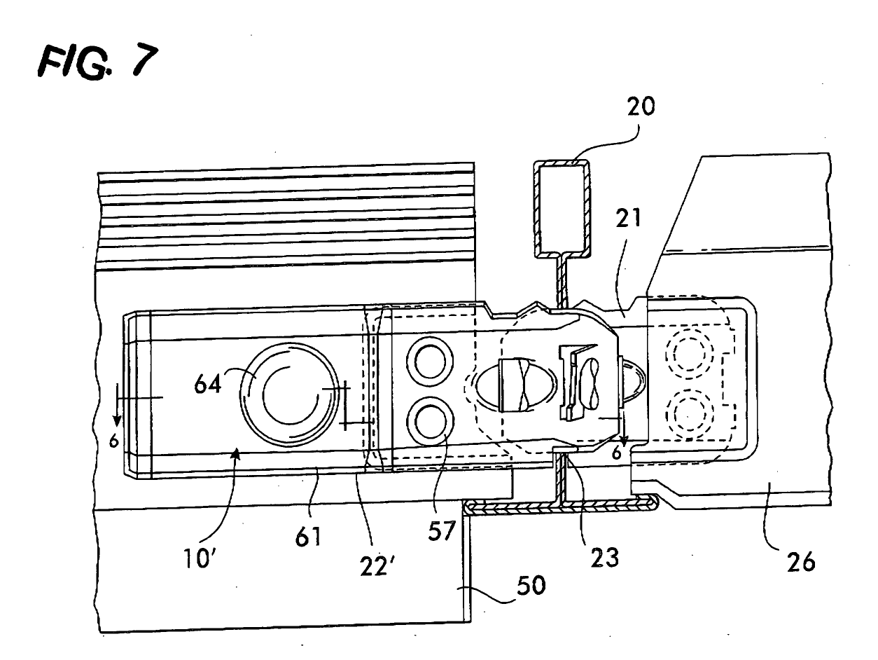

The ends of the ABs 50 with LED lights are attached to the fixed cantilevered projections 10 by, for instance, rivets 57 extending through matched rivet holes 56, in the fixed cantilevered extension 10 and the AB 50 as seen in FIG. 4. The fixed cantilevered extensions 10 fit in contoured depressions 58 in the ABs 50.

In the preferred embodiment of the present invention, a prior art second cross beam connector 22 as set forth above, is modified as shown in FIGS. 5,6, and 7, to provide an extended length that enables a second cross beam connector 22′ to be more easily inserted manually into the connection, and that provides a longer fixed cantilevered projection 10′.

In this preferred modified embodiment, second cross beam connector 22′ is formed by extending second cross beam connector 22 at 61 to provide a manual grip 62 with greater surface to grasp with fingers 63 than the surface of the second cross beam connector 22 by itself. A suitable surface configuration, such as a circular hump 64, enables the second cross beam connector 22′ to be more easily manually inserted into the connection, as shown in FIG. 5, wherein fingers 63 grasp grip 62 of the extended second cross beam connector 22′.

The longer fixed cantilevered extension 10′ also provides a more stable support for AB 50. Alternatively, such a modified fixed cantilevered extension 22′ could be formed of two segments by fastening an extended portion to the second cross beam connector 22.

The invention, among other benefits, permits a first group of workers, skilled in installing prior art suspended prior art ceilings with folded sheet metal beams 20, 26, and 27, to create a suspended ceiling with the fixed cantilevered projections 10 installed at locations where the ABs 50 with LED lights are to be later installed. No panels are inserted at these locations during the initial construction of the suspended ceiling, so the fixed cantilevered extensions 10 are left exposed.

Later, a second group of workers, preferably electricians skilled in installing ABs with LED lights, simply connect the ABs 50 to the fixed cantilevered extensions 10 installed earlier by the first group of workers, and then make the electrical connections.

Once the ABs 50 with LED lights are secured to the fixed cantilevered extensions 10 of the invention, and the LED lights electrically wired, the openings adjacent such ABs 50 are closed by simply laying suitably sized ceiling panels on the flanges 53,54 of the ABs 50 and the flanges 66 of prior art roll-formed sheet metal beams of the suspended ceiling surrounding the ABs 50.

In the procedure described above, the invention permits the ceiling to maintain its compliance with particularly the earthquake requirements of the building codes, notwithstanding the lights in the ceiling are installed after the installation of the ceiling itself. The cantilevered supports of the invention make such continued compliance possible.

What is claimed is:

1. In a grid connection in a suspended ceiling, a connector-to-connector lock between opposing first and second connectors fixed on the ends of first and second cross beams, that are inserted by means of the cross beams, and extend, through a slot in, and connect with, a main beam, and with each other, from opposite directions, the improvement comprising
a fixed cantilevered extension from the main beam, formed by inserting a second connector through the slot without a cross beam fixed thereto, that is capable of having attached thereto, and supporting therefrom, an aluminum beam with LED lights.

2. The structure of claim 1, wherein the second connector that forms the fixed cantilevered extension has an extended portion that enables the second connector to be more easily manually inserted through the slot, and then more easily connected to an AB.

3. In a suspended ceiling grid connection that resists earthquakes in compliance with code requirements, a connector-to-connector lock between opposing first and second connectors that are connected to the ends of first and second cross beams, and that are inserted by means of the cross beams, and that extend, through a slot in, and connect with, the main beam, and with each other, from opposite directions;
the improvement comprising
a method of forming a fixed cantilevered extension from the main beam, by inserting a second connector alone, before the connection is made, that is capable of having subsequently attached thereto, and supporting therefrom, an aluminum beam with LED lights.

4. The method of claim 3, wherein the second connector has an extended portion that enables the second connector to be more easily manually inserted through the slot, and then more easily connected to an AB.

5. The method of claim 3, wherein
(a) the fixed cantilevered extensions of the invention are installed by workers skilled in erecting suspended ceilings; and then
(b) the aluminum beams with LED lights are secured at a later time to the fixed cantilevered extensions and connected electrically to a power line by a second group of workers skilled in electrical installations.
